(19) United States
(12) Patent Application Publication
(10) Pub. No.: US 2010/0161548 A1
(43) Pub. Date: Jun. 24, 2010

(54) SYSTEM AND METHOD FOR CAPACITY PLANNING IN AN INFORMATION NETWORK

(76) Inventors: Cynthia Dolan, Hercules, CA (US); Charles Massey, Roswell, GA (US); Rene Fernando Molina Mac-Dougall, Alpharetta, AL (US); Samuel F. White, Marietta, GA (US); Jermaine H. Trott, Atlanta, GA (US); Michael Zanolini, Poway, CA (US)

Correspondence Address: AT & T Legal Department - FKM, AT & T LEGAL DEPARTMENT,, ATTN: PATENT DOCKETING ROOM 2A-207, BEDMINSTER, NJ, 07921, US

(21) Appl. No.: 12/342,845

(22) Filed: Dec. 23, 2008

(51) Int. Cl. G06F 17/30

(52) U.S. Cl. 707/602; 707/E17.03

(57) ABSTRACT

A systems and method for extracting utilization data from a plurality of system monitoring products, storing the extracted utilization data in a data warehouse, correlating the extracted utilization data extracted from the plurality of system monitoring products, retrieving utilization data for a group of systems from the data warehouse and displaying the retrieved utilization data on a display.

### BACKGROUND

In information technology, capacity planning is the process of estimating the space, computer hardware, software and connection infrastructure resources that will be needed over some future period of time. The process of provisioning new applications onto existing systems, bringing in new systems, increasing capacity on existing systems, working with applications to identify constraints on current systems and retiring old systems all require a planner to view utilization data for a large number of systems. This process can be incredibly time consuming and requires a large number of human resources.

Visibility into the utilization of systems is limited to the few specialists in capacity planning capable of reading and interpreting data in esoteric tool sets. Currently, there are several different products that exist to monitor system utilization. Each has a presentation layer for viewing the utilization data, but there is a steep learning curve for each product. Some of the products require the user to download the software onto their desktop computer. All of the products require some basic understanding of how the system works.

Additionally, existing products are generally geared for viewing a single system at a time and do not allow ad hoc groupings of systems. However, viewing groups of systems is a common requirement for capacity planning. Many applications have support staff which monitor the utilization on systems that they use. The support staff may monitor growth, view the impact of code changes or for problem analysis. It may be beneficial to see the utilization for all of the systems in their application or a certain subset of the systems in a group in a manner that may be understood by any user that does not necessarily specialize in capacity planning. Size may also be an issue with commercial products since many commercial products cannot manage large numbers of systems.

### SUMMARY OF THE INVENTION

A method for extracting utilization data from a plurality of system monitoring products, storing the extracted utilization data in a data warehouse, correlating the extracted utilization data extracted from the plurality of system monitoring products, retrieving utilization data for a group of systems from the data warehouse and displaying the retrieved utilization data on a display.

A system having a processor adapted to extract utilization data from a plurality of system monitoring products and correlate the extracted utilization data and a data warehouse adapted to store the extracted data, wherein the processor retrieves utilization data from the data warehouse for a group of systems.

### BRIEF DESCRIPTION OF THE DRAWINGS

FIG. 1 shows a schematic view of a system according to an exemplary embodiment of the present invention.

FIG. 2 shows a flow diagram of a method according to an exemplary embodiment of the present invention.

FIG. 3 shows an exemplary screen view of a system utilization data for a group of systems according to the present invention.

FIG. 4 shows an exemplary screen view of a help application according to an exemplary embodiment of the present invention.

### DETAILED DESCRIPTION

The exemplary embodiments of the present invention may be further understood with reference to the following description and the appended drawings, wherein like elements are referred to with the same reference elements. The exemplary embodiments relate to a system and method for capacity planning. In particular, exemplary embodiments of the present invention describe a method for viewing large amounts of system utilization data and for providing a user with guidance on how to interpret the data.

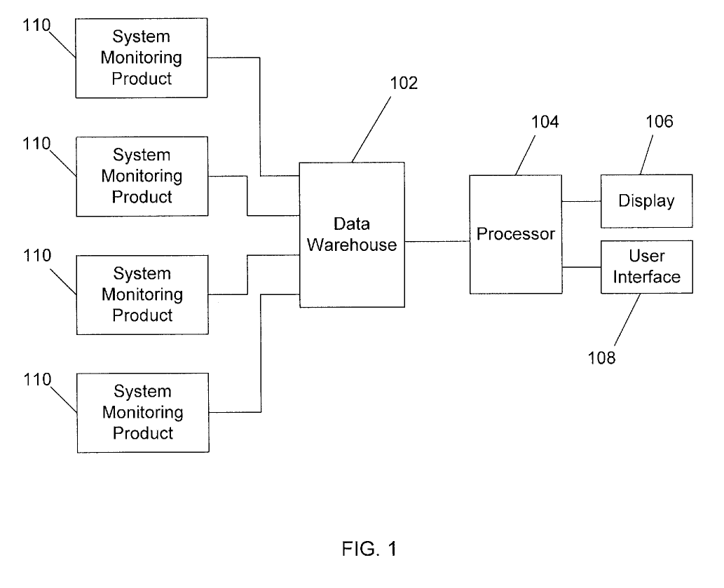

As shown in FIG. 1, a system 100 according to an exemplary embodiment of the present invention includes a data warehouse 102, a processor 104 and a display 106. The data warehouse 102 is in communication with a plurality of system monitoring products 110 such that the data warehouse 102 may store utilization data that is extracted from the plurality of system monitoring products 110. The plurality of system monitoring products 110 may include, for example, BMC's Perform, Microsofts's MOM and Unix system utility SAR. The processor 104 may be connected to the data warehouse 102 such that the processor 104 may process utilization data collected in the data warehouse 102. The utilization data may be processed and displayed on the display 106 in a comprehensive format such as, for example, a chart. The system 100 may further comprise a user interface 108 that is connected to the processor 104 and the display 106 such that a user may enter a variety of parameters to retrieve and display a desired utilization data from the data warehouse 102 on the display 106.

The data warehouse 102 may be in, for example, an Oracle Real Application Clusters (RAC) environment, which allows multiple computers to run a relational database management software while accessing a single database. The relational database stores data in the form of a table along with a relationship among the data, which is also stored in the form of a table. Thus, the stored data may be retrieved as a function of the relationship between the data of a variety of the system monitoring products 110. Additionally, the table form of the stored data permits the processor 104 to draw the data in a chart format to be displayed on the display 106. However, those skilled in the art will understand that the exemplary embodiments are not limited to storing data in tables. Any manner of storing data and/or relational data may be used.

The processor 104 may be loaded with user-friendly interface components that may be accessible to the user via the user interface 108. The user interface 108 may be, for example, FLEX-based, including components such as buttons, list boxes, data grids, text controls and layout containers. Thus, the user may enter desired parameters via the user interface 108 to retrieve extracted data from the data warehouse 102. It will be understood by those of skill in the art that the processor 104, the display 106 and/or the user interface 108 may be components of a computer that is used to view and assess the utilization data of the plurality of system monitoring products 110.

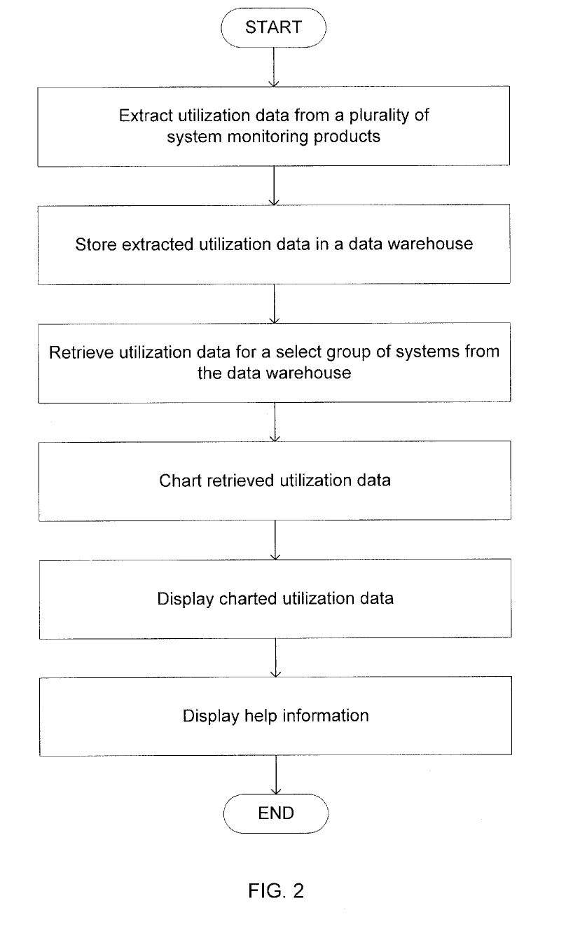

FIG. 2 shows a method 200 according to an exemplary embodiment of the present invention, using the system 100, as described above. The method 200 comprises extracting utilization data from a plurality of system monitoring products 110, in a step 210. The data may be extracted at a predetermined time or periods. For example, the data may be extracted, at a given time every day or at given times multiple times a day. This extracted data is stored into the data warehouse 102, in a step 220. The extracted data and the relationship between the data from each of the plurality of system monitoring products 110 may be stored in the data warehouse 102, in table form. The relationship may be used to correlate information collected from the various system monitoring products 110.

In a step 230, the user may the retrieve utilization data of a selected group for viewing on the display 108. The group of utilization data to be retrieved may be selected by the user via the user interface 108. The user may select either a natural group that is predetermined based upon the relationship of the groups relative to one another or create an arbitrary group of systems. The user may select groups by specifying a name of the group, a name of an application, an IP address or, for partitioned systems, a frame. It will be understood by those of skill in the art, however, that a user may select utilization data for any group of systems using a variety of specifications. The user may also specify a desired time period to be viewed.

Once a desired group of systems and a desired time period is selected, the user may select additional parameters such as a desired view. The view may include options such as a system view, an overview, a processor view, a memory view and an Input/Output (IO) view. The various views may determine the charts to be displayed. A system view may show utilization data for individual systems within the group and an overview may show an overall utilization data for all of the systems of the selected group. The processor view, the memory view and the IO view may include charts pertaining specifically to utilization data of the processor, memory and IO, respectively. Each of the views may include multiple charts for display.

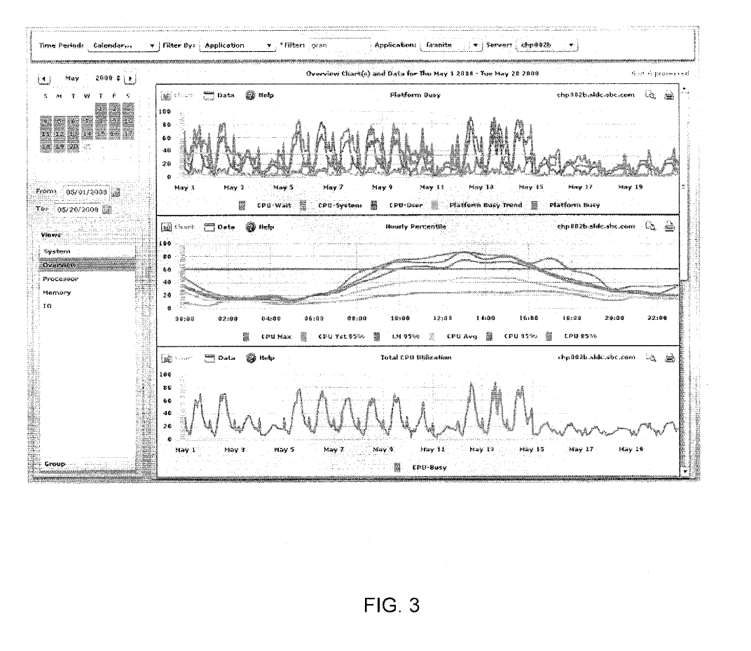

Once the desired parameters, including group, time period and view are selected, the processor 104 charts the retrieved utilization data in the desired view, in a step 240. The charted utilization data is then displayed on the display 106 so that the charted utilization data may be assessed by the user. The data used to chart the utilization data in the desired view may be downloaded to a spreadsheet application such as Excel, which also stores data in a table form such that it is easily convertible into a variety of chart views. Thus, the data may be saved, in the excel format, to a memory such that the data may be re-charted and/or reviewed at a later time. As shown in FIG. 3, the display 106 may show the charted utilization data and provide the user interface 108. The charts specify a time period being displayed and may be grouped according to resource type. The user interface 108 may include controls for specifying the time period, for selecting the group of systems to view utilization data for and for selecting an application. The user interface 108 may also include controls for viewing the charts, viewing the retrieved utilization data and viewing help information. It will be understood by those of skill in the art, however, that a variety of other controls may also be included in the user interface 108.

In the example shown in FIG. 3, the user has selected a group of systems based upon application along with a time period of May 1, 2008 to May 20, 2008. Additionally, the user has selected an overview view, which may include charts such as a Platform Busy Chart, an Hourly Percentile chart and a Total CPU Utilization Chart. It will be understood by those of skill in the art, however, that a variety of other charts may be displayed in the overview view. Each of the charts may include a variety of metrics, which may also be determined by the user.

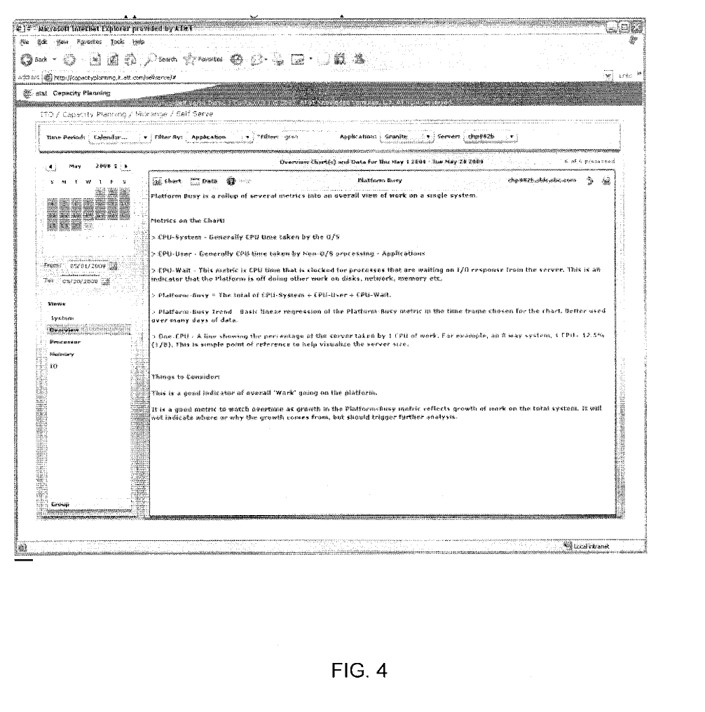

In a further embodiment of the method, the method may also include, in a step 260, displaying help information for the charts displayed in the step 250. Each of the displayed charts may have help information built into the chart, which helps the user to interpret the measurement data. Thus, if the user desires help in interpreting the charted information, the user may simply select the help control via the user interface to display the help information. For example, as shown in FIG. 4, the displayed help information may include explanations of the various groups of charts and a description of the metrics shown in the charts. The help information may also include factors that the user may want to consider when assessing the charts for capacity planning. In the example shown, the user has selected the help control for the Platform Busy Chart. The help information shows a description of the Platform Busy Chart along with a list and description of the various metrics included in the chart.

It will be understood by those of skill in the art that the above described system and method will allow non-capacity planners to interpret utilization data on any monitored system. Thus, specialized capacity planners to focus their time on more complex capacity issues. Additionally, the system of the present invention is flexible. Charts, definitions and descriptions are kept in the database such that additional charts may be added as necessary. The database warehouse 102 extracts only a subset of data collected by the plurality of system monitoring products 110, which results in fast response time despite the collection of hourly data for long periods of time over large numbers of systems.

It will be apparent to those skilled in the art that various modifications and variations can be made in the structure and the methodology of the present invention, without departing from the spirit or scope of the invention. Thus, it is intended that the present invention cover the modifications and variations of this invention provided that they come within the scope of the appended claims and their equivalents.

What is claimed is:

1. A method, comprising:
extracting utilization data from a plurality of system monitoring products;
storing the extracted utilization data in a data warehouse;
correlating the extracted utilization data extracted from the plurality of system monitoring products;
retrieving utilization data for a group of systems from the data warehouse; and
displaying the retrieved utilization data on a display.

2. The method of claim 1, further comprising:
charting the retrieved utilization data in a chart for displaying the retrieved utilization data.

3. The method of claim 2, further comprising:
displaying help information for interpreting the charted utilization data.

4. The method of claim 3, wherein the help information is built into each of the displayed charts.

5. The method of claim 1, further comprising:
storing the retrieved data in a spreadsheet form.

6. The method of claim 1, further comprising:
selecting the group of systems for which the utilization data is to be retrieved.

7. The method of claim 1, wherein the group of systems is created by a user.

8. The method of claim 1, further comprising:
selecting a time period for the utilization data to be retrieved.

9. The method of claim 2, wherein charting the retrieved utilization data includes selecting a view to be displayed.

10. The method of claim 1, wherein storing the extracted data in the data warehouse includes storing the extracted data and a relationship between the extracted data in a table form.

11. A system, comprising:
a processor adapted to extract utilization data from a plurality of system monitoring products and correlate the extracted utilization data; and
a data warehouse adapted to store the extracted data, wherein the processor retrieves utilization data from the data warehouse for a group of systems.

12. The system of claim 11, further comprising:
a display displaying the retrieved utilization data.

13. The system of claim 12, wherein the retrieved utilization data is displayed in a chart.

14. The system of claim 13, the display displaying help information for interpreting the chart.

15. The system of claim 14, wherein the help information is built into the chart.

16. The system of claim 11, wherein the retrieved data is stored in a spreadsheet form.

17. The system of claim 12, further comprising:
a user interface for selecting the group of systems for which the utilization data is to be displayed.

18. The system of claim 17, wherein a time period for the utilization to be retrieved is selected via the user interface.

19. The system of claim 11, the data warehouse storing the extracted data and a relationship between the extracted in a table form.

20. A computer readable storage medium including a set of instructions operable by a processor, the set of instructions being operable to:
extract utilization data from a plurality of system monitoring products;
store the extracted utilization data in a data warehouse;
correlate the extracted utilization data extracted from the plurality of system monitoring products;
retrieve utilization data for a group of systems from the data warehouse; and
display the retrieved utilization data on a display.
